(19) United States
(12) Patent Application Publication
(10) Pub. No.: US 2017/0076372 A1
(43) Pub. Date: Mar. 16, 2017

(54) SOFTWARE LICENSE TRADING SYSTEM

(71) Applicant: International Business Machines Corporation, Armonk, NY (US)

(72) Inventors: James R. Kozloski, New Fairfield, CT (US); Clifford A. Pickover, Yorktown Heights, NY (US); Maja Vukovic, New York, NY (US)

(21) Appl. No.: 14/855,443

(22) Filed: Sep. 16, 2015

(51) Int. Cl. G06Q 40/04; G06F 21/62

(52) U.S. Cl. CPC G06Q 40/04; G06F 21/6218

(57) ABSTRACT

A method, a computer program product, and a computer system for computer implemented software-as-a-service (SaaS) license trading. A computer evaluates license offerings for a SaaS capability accessible by an application program interface, in response to receiving from a user a request for a license for the SaaS capability. The computer evaluates one or more cognitive requirements, based on functional features. The computer determines one or more matching SaaS capabilities and licenses thereof. The computer evaluates attributes of one or more providers and attributes of the one or more matching SaaS capabilities and the licenses thereof. The computer places bids for the one or more matching SaaS capabilities and the licenses thereof.

### BACKGROUND OF THE INVENTION

The present invention relates generally to computer implemented software-as-a-service (SaaS) license trading, and more particularly to a SaaS license trading system with a cognitive license broker.

The problem of how to apply, monitor, and enforce context-dependent trading of licenses to software is no longer trivial. Today, traditional contexts, such as home, office, charity, government, and educational, no longer represent clearly demarcated instances of a use-case. Furthermore, with BYOD (bring-your-own-device) devices, wearable devices, implantable devices, etc., there are no longer clear device indicators of a license context. While the possibility of making licenses more generic is always an option, for certain legal liability protection and due to other IP (Internet protocol) constraints, the need to maintain and facilitate context-dependent licenses and trading remains.

### SUMMARY

In one aspect, a method for computer implemented software-as-a-service (SaaS) license trading is provided. The method comprises evaluating, by a computer, license offerings for a SaaS capability accessible by an application program interface, in response to receiving from a user a request for a license for the SaaS capability. The method further comprises evaluating one or more cognitive requirements based on functional features, determining one or more matching SaaS capabilities and licenses thereof, evaluating attributes of one or more providers and attributes of the one or more matching SaaS capabilities and the licenses thereof, and placing bids for the one or more matching SaaS capabilities and the licenses thereof.

In another aspect, a computer program product for computer implemented software-as-a-service (SaaS) license trading is provided. The computer program product comprises a computer readable storage medium having program code embodied therewith. The program code is executable to: evaluate license offerings for a SaaS capability accessible by an application program interface, in response to receiving from a user a request for a license for the SaaS capability; evaluate one or more cognitive requirements, based on functional features; determine one or more matching SaaS capabilities and licenses thereof; evaluate attributes of one or more providers and attributes of the one or more matching SaaS capabilities and the licenses thereof; and place bids for the one or more matching SaaS capabilities and the licenses thereof.

In yet another aspect, a computer system for computer implemented software-as-a-service (SaaS) license trading is provided. The computer system comprises one or more processors, one or more computer readable tangible storage devices, and program instructions stored on at least one of the one or more computer readable tangible storage devices for execution by at least one of the one or more processors. The program instructions are executable to evaluate license offerings for a SaaS capability accessible by an application program interface, in response to receiving from a user a request for a license for the SaaS capability. The program instructions are executable to evaluate one or more cognitive requirements, based on functional features. The program instructions are executable to determine one or more matching SaaS capabilities and licenses thereof. The program instructions are executable to evaluate attributes of one or more providers and attributes of the one or more matching SaaS capabilities and the licenses thereof. The program instructions are executable to place bids for the one or more matching SaaS capabilities and the licenses thereof.

### BRIEF DESCRIPTION OF THE SEVERAL VIEWS OF THE DRAWINGS

FIG. 1 is a diagram showing a computer implemented computer implemented software-as-a-service (SaaS) license trading system, in accordance with one embodiment of the present invention.

FIG. 2 is a flowchart showing operational steps for computer implemented software-as-a-service (SaaS) license trading, in accordance with one embodiment of the present invention.

FIG. 3 is a diagram illustrating components of a computer device hosting a computer implemented software-as-a-service (SaaS) license trading system shown in FIG. 1, in accordance with one embodiment of the present invention.

### DETAILED DESCRIPTION

Embodiments of the present invention disclose a computer system for license trading among different users of disparate software across vendors. For example, the computer system for license trading facilitates license trading for a user who wants to swap one of his three PhotoShop® licenses for another user's one MS Office® license and wishes to do this in a legal manner. The computer system for license trading manages any fees, permissions, restrictions, etc. The computer system is capable of tracking the history of trading, the number of requests, and the number of license offers, to obtain the most optimized license pricing/trading pairs.

The computer system for license trading also facilitates auctioning and trading of licenses across many vendors who subscribe to the service. The computer system for license trading encourages diffusion of software developers' products to users. Software developers will also want to use the computer system for license trading to satisfy users.

If vendors provide this trading option, product “stickiness” will be increased; “stickiness” refers to the continued use of a product or service. For example, after years of using products with this trading option for licenses, users will not be inclined to switch to vendors who do not provide this trading option for licenses.

Bundled software licenses may be traded; for example, a license for Foursquare® API and Yelp® API may be traded in real-time for Facebook® API license and an Opentable® API license. This will be the scenario when the application that requires these licenses needs to adapt on the fly, and replace existing APIs (Foursquare® and Yelp®) with capabilities of Facebook® and Opentable®, due to runtime or business constraints. In this document, API stands for application programming interface.

REST APIs (Representational state transfer application programming interfaces) have brought the power of reuse within reach of individual developers at Internet-scale through consumability. The developers now have cheaper, pay-per-use access to deep computing capabilities and vast amounts of data that were hitherto hidden behind closed enterprises. The overall result is today's surging API ecosystem. This results in a high number of APIs available and their corresponding licenses. Furthermore, licenses may be created for personal or professional use. Developers often build new capabilities based on the existing APIs. The computer system supports auctions/trading of bundled licenses of APIs/software packages. Such a computer system receives a request for a package of licenses for a set of APIs/software. The computer system manages the current demand and availability of licenses.

Furthermore, the computer system may span multiple cloud providers, and offer its capabilities as part of a cloud broker system. For example, with the cloud broker system, a user can trade a license for running VMWare® converter in Amazon® cloud for a license to run Racemi® API in Softlayer®. These trades of licenses can be done at run-time, and seamlessly; as a result, the computer system supports resiliency of services. For example, if user's VMWare® converter is not responsible, the user quickly needs an alternative migration tool/license. The computer system for license trading can also enable for fractional license usage. For example, a user has a trial license for BlueMix® and allocation of 2 GBs to run user's sample services. The user has used 500 MB on BlueMix® and offers the remaining allocation through trading system, in exchange for a license for Amazon® CloudWatch service.

Embodiments of the present invention provides a solution for the need to maintain and facilitate context-dependent licenses and trading. The solution is provided by a cognitive license broker in a computer implemented software-as-a-service (SaaS) license trading system. A cognitive license broker facilitates the trading of license {A,B,C} for applications (or APIs) that serve the same, similar, or complementary purposes:
{A, B, C, . . . }→Cognitive license broker→{D, E, F, . . . }
   For example, user 1 intends to trade paint program A for paint program D from user 2. Paint program D has similar or complementary features. In order to embody these features, a software feature database may be employed by a trans-vendor service that enables the trading of software licenses. In addition, complementary software may be automatically selected or suggested if a user indicates a desire for complementary software. If desirable, users may provide their inputs to the database. These inputs may be weighted according to the structure of a social network. For example, inputs of users that are close to the user who desires for similar or complementary by some measures of social network analysis may be considered and weighted more heavily than users unknown to the user. Of course, the opinions of “experts” may also have a strong weighting. The cognitive license broker can also take into considerations such aspects as ease of use, security, and other features.

The cognitive license broker may consider cognitive needs of a user when making selections or suggestions for licenses. For example, a user may be assessed to have certain needs with respect to cognitive characteristics of the user and cognitive loads of the software that are placed upon the user. For example, a user may not even realize that he/she may find an application to be same, similar, or complementary with respect to cognitive load, ease of use, level of distraction of GUI (graphical user interface) elements, etc. The cognitive license broker may determine these needs by monitoring user's use of current software, including difficulty of using some functions, need to enlarge certain GUI elements, need to adjust audio volume, a fall-off of efficiency due to distractions provided by the software or other software running at the same time, etc. Someone with autism, pre-Alzheimer, or who is below a certain age may have certain use patterns, needs, and desires. The cognitive license broker may take these needs and characteristics into account. Alternatively, a user may consciously realize certain cognitive needs and desires which may be specified in a profile for a user or a group of users. The profile may be used by the cognitive license broker when making selections or suggestions for licenses. In group homes (e.g. an assisted care facility), such profiles may be established by caregivers.

A solution of context-dependent licensing trading will best be dealt with by the cognitive license broker in the computer implemented SaaS license trading system. The cognitive license broker is capable of monitoring and determining the use-case within the application. The cognitive license broker may notify a user: “Your license applies only to home use, but you are using this tool for work. You now wish to trade licenses. Please upgrade (or select “A” to TOGGLE) your license now.” The cognitive license broker may query (when appropriate): “You appear to be using this application for work. Would you like us to log a work use and switch the license for the next hour before your trade?”

The task then is how to increase accuracy of a context-monitoring application license in the real world so as to facilitate proper and legal trading of licenses. One option is to model the user himself and to correlate actions, physiological measures, location, posture, and facial expressions with different use case contexts. For example, when a user is in a coffee shop, he may actually be working. The posture monitoring aspect of a context-sensitive license may be activated to determine that work is typically conducted while standing. The confidence that any application used in this coffee shop while standing is actually being used for work is then increased. Hence, when an application that is licensed for home use only is used, the system is able to alert the user that the license must be upgraded.

In one embodiment, software license trading requests are obtained from a requester for a target server referencing specific software (or APIs) and then redirected to the cognitive license broker. The requester of software license is then notified of the results. Provisioning is handled on a just-in-time basis by the cognitive license broker as requested by the trading that makes necessary licenses available.

The information of license traders may be matched with the set of software providers to determine applicable licenses and traders as well as pricing and usage rates. If desirable, software license protection is performed comprising software license management and online software license enforcement, wherein individual licenses are provided for regulating the use of a software product, and the software product is individualized while being downloaded from a license server, and the execution of each individualized software product is monitored in agreement with the individual license terms corresponding to the individual software download. If desirable, a license server initializes a license trading database by receiving a license description that includes component license descriptions for component software products in a package. A license is granted to the client when the client is allowed to receive via a trade the license according to a license policy.

A license server may partition groups of users or potential users into “virtual organizations” such that the number of copies of a software program permitted for use based on license entitlements may be assigned to the virtual organization as a proxy for the users. Virtual organizations may then trade these licenses according to the current invention. Such an arrangement benefits users of a specific service, piece of software, API, etc., if different groups of users use the software in non-overlapping usage patterns that vary over daily, weekly, monthly, and even annual cycles. Given the use-case identifying components of the disclosed invention, further analysis can provide a view that reveals certain use-cases across users that are non-overlapping. A license server may be aware of various kinds of software and APIs, such as free software and proprietary software.

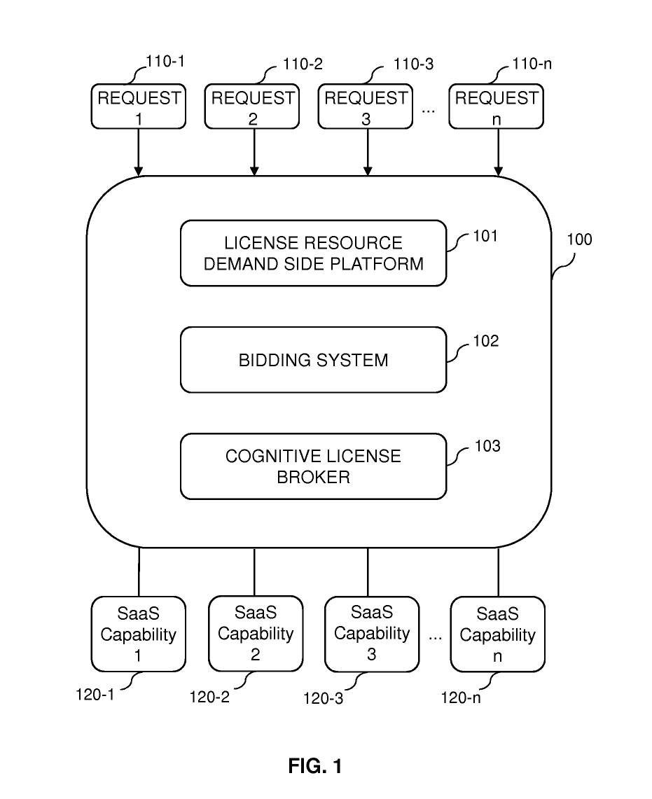

FIG. 1 is a diagram showing computer implemented software-as-a-service (SaaS) license trading system 100, in accordance with one embodiment of the present invention. Computer implemented SaaS license trading system 100 comprises license resource demand side platform 101, bidding system 102, and cognitive license broker 103. License resource demand side platform 101 provides an interface between computer-implemented SaaS license trading system 100 and users. License resource demand side platform 101 receives from the users one or more requests for licenses for SaaS capabilities. For example, as shown in FIG. 1, n requests are shown as request 1 110-1, request 2 110-2, request 3 110-3, through request n 110-n. Bidding system 102 is responsible for querying resources, prices, resource properties of software, for confirming and authenticating SaaS license trading, for accessing and configuring resources, and for finally executing jobs of the one or more requests. Cognitive license broker 103 evaluates cognitive requirements and filters matching SaaS capabilities and licenses, based on functional features. FIG. 1 shows multiple SaaS capabilities, SaaS capability 1 120-1, SaaS capability 2 120-2, SaaS capability 3 120-3, through SaaS capability n 120-n. Each of the SaaS capabilities has one or more licenses (e.g. a consumer license, a business license, a license for free use, or a license negotiated as part of a larger contract).

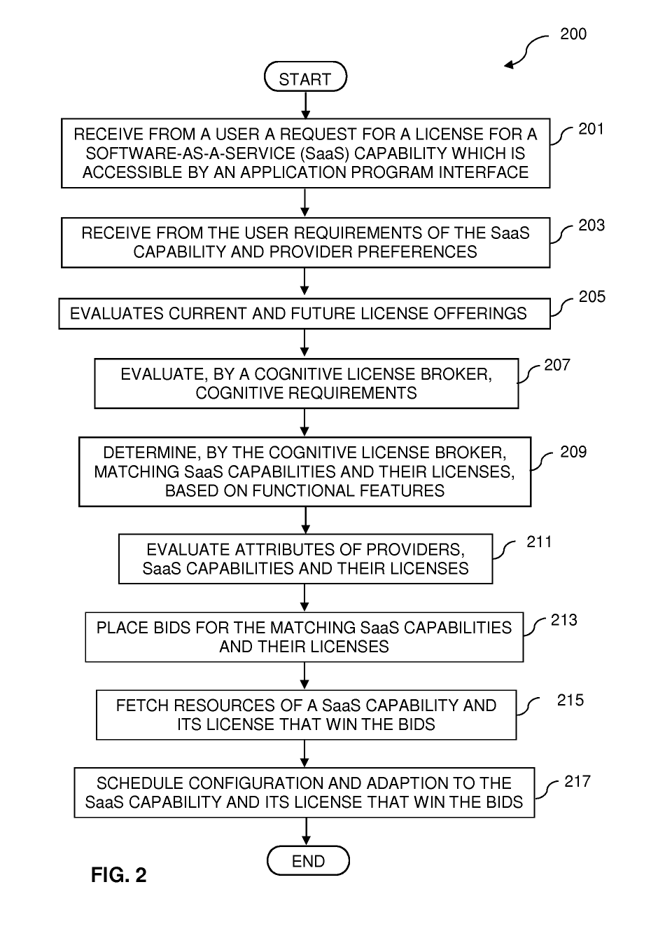

FIG. 2 is flowchart 200 showing operational steps for computer implemented software-as-a-service (SaaS) license trading, in accordance with one embodiment of the present invention. At step 201, computer implemented SaaS license trading system 100 (shown in FIG. 1) receives from a user a request for a license for a license for a SaaS capability. The SaaS capability is accessible by an application program interface (API). At step 203, computer implemented SaaS license trading system 100 receives from the user one or more requirements the SaaS capability and one or more provider preferences. At step 205, computer implemented SaaS license trading system 100 evaluates current and future license offerings for the SaaS capability. At step 207, cognitive license broker 103 evaluates one or more cognitive requirements. At step 209, cognitive license broker 103 determines one or more matching SaaS capabilities and their licenses based on functional features. The one or more matching SaaS capabilities have similar or complementary features compared to the SaaS capability which is requested by the user. At step 211, computer implemented SaaS license trading system 100 evaluates attributes of one or more providers and attributes of the one or more matching SaaS capabilities and their licenses. For example, the attributes include availability, cost, accessibility, maintenance, productivity, reliability, scalability, and security of each SaaS capability. At step 213, bidding system 102 places bids for the one or more matching SaaS capabilities and their licenses. At step 215, computer implemented SaaS license trading system 100 fetches one or more resources of a SaaS capability and its license that win the bids. At step 217, computer implemented SaaS license trading system 100 schedules configuration and adaption to the SaaS capability and license that win the bids.

The following mathematical models are used by bidding system 102 to bid for one or more matching SaaS capabilities and their licenses. Bidding system 102 takes the advantage of mathematical models such as ones in the work of Engel et al (“Bid Expressiveness and Clearing Algorithms in Multiattribute Double Auctions”, EC'06, Jun. 11-15, 2006, Ann Arbor, Mich., USA). Each license is defined by a vector of attributes including availability, cost, accessibility, maintenance. Productivity, reliability, scalability, and security of each SaaS capability. The vector x of the attributes can be expressed by

x=(x₁, . . . ,xₙ)

where xⱼ is part of Xⱼ. The vector x belongs to X which expressed as

X=Πⱼ₌₁^{m}Xⱼ

The outcome of the bids is a set of bilateral trades. A trade can be expressed as

t=(x,q,b,s,π)

where agent b buys q (>0) units of license x from seller s for payment π. For a set of trades T, Tᵢ is subset of T involving agent i. The offer set Oᵢ^{T} is a subset of T.

Agent i's willingness to pay for quantity q of license/invocations/usages x is given by

ûᵢ^{B}(x,q)=max π s.t.(x,q,i,*,π)εOᵢ^{T}

Agent i's minimum trade quantity for license x is given by

qᵢ(x)=max q s.t.∃π.(x,q,i,*,π)εOᵢ^{T}

Agent i's maximum quantity for license x is

q̅ᵢ(x)=max q s.t.

∃π.(x,q,i,*,π)εOᵢ^{T} [symbol] [symbol] ∃q′<q.(x,q′,i*,π)εOᵢ^{T}

The surplus of the trade t is given by

σ(t)=û_{b}^{B}(x,q)−ûₛ^{S}(x,q)

The Global Multiattribute Allocation Problem (GMAP) is to find the set of acceptable trades maximizing total surplus,

$${max}_{T ∈ {2}^{T}} {Σ}_{t ∈ T} σ ( t ; T \backslash \{ t \} ) s . t . ∀ i . {T}_{i} ∈ {O}_{i}^{C}$$

The Multiattribute Matching Problem (MMP) is to find a best trade for a given pair of traders,

$$MMP ( b , s ) = arg {max}_{t ∈ {O}_{b}^{T} ⋂ {O}_{s}^{T}} σ ( t )$$

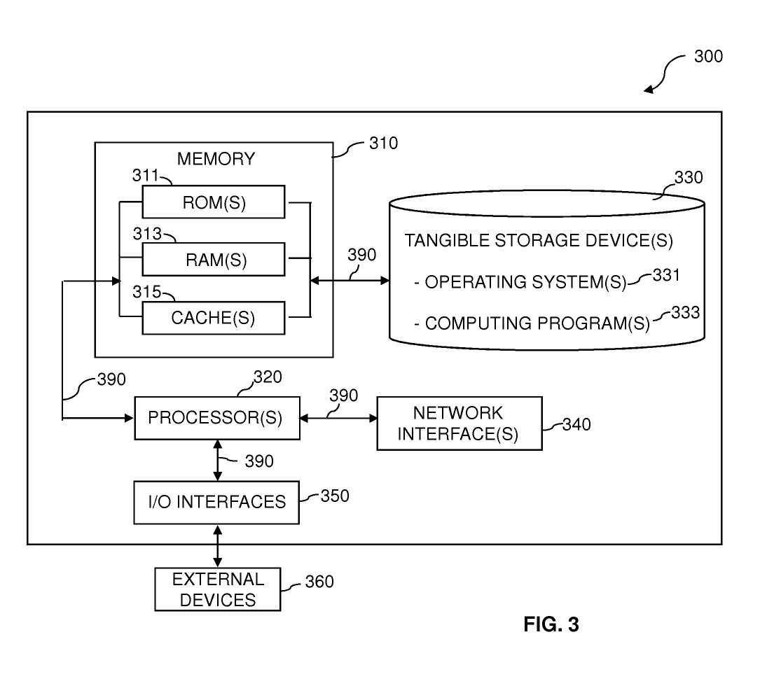

FIG. 3 is a diagram illustrating components of computer device 300 hosting computer implemented SaaS license trading system 100 shown in FIG. 1, in accordance with one embodiment of the present invention. It should be appreciated that FIG. 3 provides only an illustration of one implementation and does not imply any limitations with regard to the environment in which different embodiments may be implemented.

Referring to FIG. 3, computer device 300 includes processor(s) 320, memory 310, and tangible storage device(s) 330. In FIG. 3, communications among the above-mentioned components of computer device 300 are denoted by numeral 390. Memory 310 includes ROM(s) (Read Only Memory) 311, RAM(s) (Random Access Memory) 313, and cache(s) 315. One or more operating systems 331 and one or more computer programs 333 reside on one or more computer readable tangible storage device(s) 330. Computer implemented SaaS license trading system 100 resides on one or more computer readable tangible storage device(s) 330. Computer device 300 further includes I/O interface(s) 350. I/O interface(s) 350 allows for input and output of data with external device(s) 360 that may be connected to computer device 300. Computer device 300 further includes network interface(s) 340 for communications between computer device 300 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the “C” programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the FIGs illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for computer implemented software-as-a-service (SaaS) license trading, the method comprising:
evaluating, by a computer, license offerings for a SaaS capability accessible by an application program interface, in response to receiving from a user a request for a license for the SaaS capability;
evaluating, by the computer, one or more cognitive requirements, based on functional features;
determining, by the computer, one or more matching SaaS capabilities and licenses thereof;
evaluating, by the computer, attributes of one or more providers and attributes of the one or more matching SaaS capabilities and the licenses thereof; and
placing, by the computer, bids for the one or more matching SaaS capabilities and the licenses thereof.

2. The method of claim 1, further comprising:
receiving, by the computer, from the user, the request for the license for the SaaS capability; and
receiving, by the computer, from the user, one or more requirements of the SaaS capability and one or more provider preferences.

3. The method of claim 1, further comprising:
fetching, by the computer, one or more resources of an SaaS capability and a license thereof that win the bids; and
scheduling, by the computer, configuration and adaption to the SaaS capability and the license thereof that win the bids.

4. The method of claim 1, wherein evaluating the one or more cognitive requirements comprises assessing cognitive characteristics of the user and cognitive loads of software.

5. The method of claim 1, wherein the one or more matching SaaS capabilities have similar or complementary features compared to the SaaS capability which is requested by the user.

6. The method of claim 1, wherein the computer implemented SaaS license trading is implemented by an interface for the user to request the license for the SaaS capability, a cognitive license broker for evaluating the one or more cognitive requirements and determining the one or more matching SaaS capabilities and the licenses thereof, and a bidding system for placing the bids for the one or more matching SaaS capabilities and the licenses thereof.

7. A computer program product for computer implemented software-as-a-service (SaaS) license trading, the computer program product comprising a computer readable storage medium having program code embodied therewith, the program code executable to:
evaluate, by a computer, license offerings for a SaaS capability accessible by an application program interface, in response to receiving from a user a request for a license for the SaaS capability;
evaluate, by the computer, one or more cognitive requirements, based on functional features;
determine, by the computer, one or more matching SaaS capabilities and licenses thereof;
evaluate, by the computer, attributes of one or more providers and attributes of the one or more matching SaaS capabilities and the licenses thereof; and
place, by the computer, bids for the one or more matching SaaS capabilities and the licenses thereof.

8. The computer program product of claim 7, further comprising the program code executable to:
receive, by the computer, from the user, the request for the license for the SaaS capability; and
receive, by the computer, from the user, one or more requirements of the SaaS capability and one or more provider preferences.

9. The computer program product of claim 7, further comprising the program code executable to:
fetch, by the computer, one or more resources of an SaaS capability and a license thereof that win the bids; and
schedule, by the computer, configuration and adaption to the SaaS capability and the license thereof that win the bids.

10. The computer program product of claim 7, wherein evaluating the one or more cognitive requirements comprises assessing cognitive characteristics of the user and cognitive loads of software.

11. The computer program product of claim 7, wherein the one or more matching SaaS capabilities have similar or complementary features compared to the SaaS capability which is requested by the user.

12. The computer program product of claim 7, wherein the computer implemented SaaS license trading is implemented by an interface for the user to request the license for the SaaS capability, a cognitive license broker for evaluating the one or more cognitive requirements and determining the one or more matching SaaS capabilities and the licenses thereof, and a bidding system for placing the bids for the one or more matching SaaS capabilities and the licenses thereof.

13. A computer system for computer implemented SaaS license trading, the computer system comprising:
one or more processors, one or more computer readable tangible storage devices, and program instructions stored on at least one of the one or more computer readable tangible storage devices for execution by at least one of the one or more processors, the program instructions executable to:
evaluate, by a computer, license offerings for a SaaS capability accessible by an application program interface, in response to receiving from a user a request for a license for the SaaS capability;
evaluate, by the computer, one or more cognitive requirements, based on functional features;
determine, by the computer, one or more matching SaaS capabilities and licenses thereof;
evaluate, by the computer, attributes of one or more providers and attributes of the one or more matching SaaS capabilities and the licenses thereof; and
place, by the computer, bids for the one or more matching SaaS capabilities and the licenses thereof.

14. The computer system of claim 13, further comprising the program instructions executable to:
receive, by the computer, from the user, the request for the license for the SaaS capability; and
receive, by the computer, from the user, one or more requirements of the SaaS capability and one or more provider preferences.

15. The computer system of claim 13, further comprising the program instructions executable to:
fetch, by the computer, one or more resources of an SaaS capability and a license thereof that win the bids; and
schedule, by the computer, configuration and adaption to the SaaS capability and the license thereof that win the bids.

16. The computer system of claim 13, wherein evaluating the one or more cognitive requirements comprises assessing cognitive characteristics of the user and cognitive loads of software.

17. The computer system of claim 13, wherein the one or more matching SaaS capabilities have similar or complementary features compared to the SaaS capability which is requested by the user.

18. The computer system of claim 13, wherein the computer implemented SaaS license trading is implemented by an interface for the user to request the license for the SaaS capability, a cognitive license broker for evaluating the one or more cognitive requirements and determining the one or more matching SaaS capabilities and the licenses thereof, and a bidding system for placing the bids for the one or more matching SaaS capabilities and the licenses thereof.
